(19) United States
(12) Patent Application Publication
(10) Pub. No.: US 2015/0288188 A1
(43) Pub. Date: Oct. 8, 2015

(54) Parallel-Connected Solar Electric System

(71) Applicants: Marvin S Keshner, Sonora, CA (US); Erik Garth Vaaler, Redwood City, CA (US)

(72) Inventors: Marvin S Keshner, Sonora, CA (US); Erik Garth Vaaler, Redwood City, CA (US)

(21) Appl. No.: 14/247,746

(22) Filed: Apr. 8, 2014

(51) Int. Cl. H02J 3/38; H02M 7/537; H02M 3/335

(52) U.S. Cl. CPC H02J 3/38; H02M 3/33569; H02M 7/537

(57) ABSTRACT

Embodiments generally relate to photovoltaic solar panel installations. In one embodiment, the installation comprises an array of 4 or more solar panels and one DC to AC electrical power inverter that is connected to the AC power line. All of the solar panels are electrically connected in parallel to each other, and in parallel with the DC inputs of the DC to AC power inverter. In one aspect the solar panels are first divided into groups of two that are electrically connected in series, and then all these groups of two series-connected solar panels are electrically connected in parallel to each other and in parallel with the DC inputs of the DC to AC power inverter.

### FIELD OF INVENTION

This invention relates to photovoltaic solar panel installations for converting sunlight to DC electricity and then converting the DC electricity into AC electricity with a DC to AC inverter.

### BACKGROUND

Photovoltaic solar panels are commonly installed on rooftops or on the ground to collect sunlight and convert the sunlight into DC electricity. Most often, a large group of solar panels are connected to a single DC to AC inverter that converts the DC power from the solar panels into AC power (typically 50 or 60 Hz) and connects to the AC power line.

In common practice, the solar panels are electrically connected in series with each other into long strings that can vary from 5-30 solar panels per string. The series-connected strings are then connected in parallel to each other and in parallel to the inputs of the DC to AC converter.

The minimum length of the strings, where length in this context means the number of panels in each string, is limited by the ability of the DC to AC inverter to handle large currents and to efficiently convert power at high current and low voltage from DC to AC. For example, an array of 12 solar panels can be connected into a single string of length 12. If the solar panels are conventional 60-cell, poly-silicon, solar panels, then the string and thus the array will have an operating voltage of about 324 volts DC and an operating current of about 8 amps. Connecting the array as 4 strings of 3 panels each will produce an operating voltage of about 81 volts DC and an operating current of about 32 amps. Connecting all of the panels in parallel will produce an operating voltage for the array of about 27 volts DC and an operating current of 96 amps. Typical prior art inverters are not designed from such low operating voltages and high operating currents.

The maximum length of the strings is limited by the maximum voltage rating of the solar panels to either 600 or 1000 volts, and the maximum voltage rating of the inverter (e.g. 600 v, 1000v or + or −600 v). The single solar inverter is then required efficiently to convert DC to AC power with the operating input voltage varying over a wide range. The operating input voltages vary with length of the series-connected strings, with the intensity of the sunlight, and also with the operating temperature of the solar panels.

Recently, micro-inverters have been developed. With these devices, each solar panel or pair of solar panels has its own DC to AC inverter. The micro-inverters are connected in parallel with each other onto the AC power line.

For rooftop installations, partial shading of the array of solar panels is an important issue. Partial shading can arise from trees, power poles, chimneys, ventilation shafts and other items mounted on the rooftop. When solar panels are series-connected into long strings, and when one solar panel or a cell within one solar panel is shaded, then the power output of the entire series-connected string is reduced.

For example, consider an array of 10 solar panels, each of which is designed to produce 250 watts of electrical power in full sunlight. If one solar panel is partially shaded and only able to produce 10% of its rated power, and the other 9 solar panels are not shaded and in full sunlight, then the total power available from the array would be: 9×250 watts+0.1×250 watts=2275 watts out of a maximum of 2500 watts. However, if the 10 solar panels are connected in series, and ignoring the effect of by-pass diodes that are often included within the solar panels, the current of the string of 10 panels will be limited by the current of the shaded panel to about 10% of its maximum current. All of the panels in the string of 10 will operate at only 10% of their rated current and about 10% of their rated power. The result is only 250 watts of power produced.

Of course, solar installers design the installation to minimize shading of the solar panels. Nevertheless, some shading is common—especially on residential rooftops, where space is limited, and sources of shading are abundant and not easily modified. It is estimated by companies like Enphase Energy that partial shading of solar panels that are series-connected into strings reduces the total energy production of a residential rooftop solar installation by as much as 15-20%.

Micro-inverters (and also solar power conditioners) have been developed to reduce the impact of partial shading of the solar panels on a rooftop. Each solar panel has its own DC to AC micro-power-inverter, and the micro-inverters are all connected in parallel. If one of the solar panels is shaded and has reduced output, its inverter will deliver less power to the AC power line. But, the other solar panels and their micro-inverters are unaffected. They will continue to produce power that will depend only on the amount of sunlight collected by each and independent of the circumstances of other solar panels. With micro-inverters, one can avoid most of the reduction of total energy due to the combination of partial shading and series-connected strings of solar panels.

Unfortunately, using one micro-inverter per one or two solar panels has several serious disadvantages compared with using a single inverter for the entire rooftop solar installation. First, there are several cost disadvantages. Micro-inverters on the market today are typically 50% more expensive per watt than single inverters for the entire installation. Other aspects of a solar installation with micro-inverters are also more expensive because micro-inverters require extra mounting hardware and additional connectors. Micro-inverters also require that AC wiring is run on the roof and connected to each of the micro-inverters. Single inverters require only a small number of short DC wires.

Second, there are several reliability issues. The micro-inverters are often located underneath the solar panels. The sunlight heats the solar panels and the daytime maximum temperatures underneath the solar panels may be very high. As a result, the micro-inverters experience very large temperature cycles every day. Frequent, large temperature cycles are well-known as a key cause of failures for electronic devices. In contrast, single inverters are usually not mounted on the roof. They are mounted under the eaves of the roof, where they are not heated by direct sunlight (especially during the hot part of the day) and where they do not experience large temperature cycles each day. Also, the temperature under the eaves of the roof tends to be moderated by the thermal mass and steady internal temperature of the building. It is considerably less cold at night and less hot during the day than the rooftop. Exposure to smaller temperature cycles each day makes ensuring the reliability of single inverters much easier.

### SUMMARY

The present invention includes a photovoltaic solar panel installation, comprising an array of 4 or more solar panels) and one DC to AC electrical power inverter that is connected to the AC power line. All of the solar panels are electrically connected in parallel to each other, and in parallel with the DC input of the DC to AC power inverter. In one aspect the solar panels are first divided into groups of two that are electrically connected in series, and then all these groups of two series-connected solar panels are electrically connected in parallel and in parallel with the DC input of the DC to AC power inverter.

### BRIEF DESCRIPTION OF DRAWINGS

FIG. 1—A solar installation with all solar panels connected in parallel to an inverter, according to one embodiment.

FIG. 2—A solar installation with all solar panels connected in parallel to an inverter according to another embodiment.

FIG. 3—A solar installation with all solar panels (301) connected in parallel to an inverter according to another embodiment.

FIG. 4A—An array of solar panels positioned relative to an inverter according to one embodiment.

FIG. 4B—An array of solar panels positioned relative to an inverter according to another embodiment.

FIG. 4C—An array of solar panels positioned relative to an inverter according to yet another embodiment.

FIG. 5A—A top down view of a solar installation with the inverter positioned relative to the solar panels and a sun shade according to one embodiment.

FIG. 5B—A cross section view (through CC′) of the embodiment of FIG. 5A

FIG. 6—A functional diagram for a solar inverter (600) designed for use with an array of solar panels all connected in parallel, and optimized for low input voltages and high input currents, according to one embodiment.

FIG. 7—A solar installation with the solar panels (701) divided into groups of two and electrically connected according to one embodiment.

### DETAILED DESCRIPTION

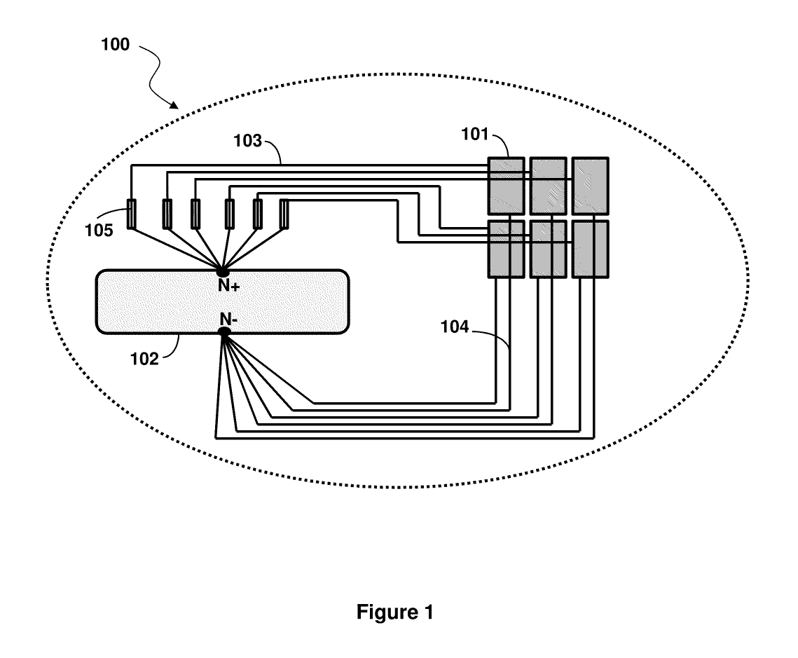

In one embodiment of a parallel-connected solar installation 100, shown in FIG. 1, each panel 101 of an array of at least 4 photovoltaic solar panels is electrically connected to a single power inverter 102 to form a solar installation that converts the DC electricity generated by the solar panels into AC electricity, at the usual power line frequency (50 or 60 Hz). When connected to the utility power lines, the inverter synchronizes the phase of its output with the phase of the voltage on the power line. Typically, the panels 101 are mounted on top of a roof, in a fixed position, facing toward the sun.

A positive wire 103 and a negative wire 104 connect each of the solar panels electrically to inputs N+ and N− of inverter 102 so that all of the solar panels are connected in parallel and in parallel with the inputs of the inverter. These parallel electrical connections may be achieved with a pair of wires 103, 104 running from each solar panel to the inverter. A fuse 105 is placed in series with each one of the positive wires 103 between the corresponding panel 101 and inverter 102. In the event of a solar panel failing and becoming a short circuit, the corresponding fuse will blow and prevent all of the other solar panels in the group from dumping their electrical power into the failed panel and possibly starting a fire.

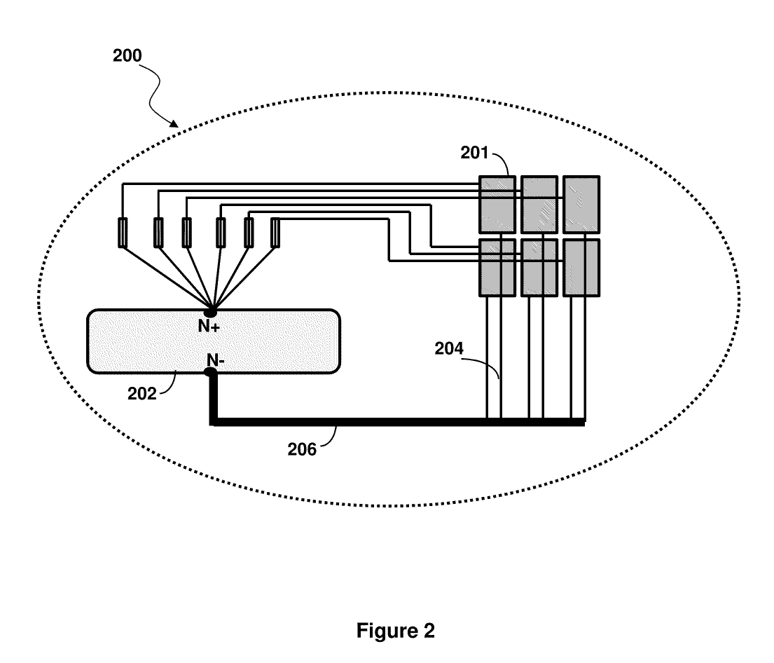

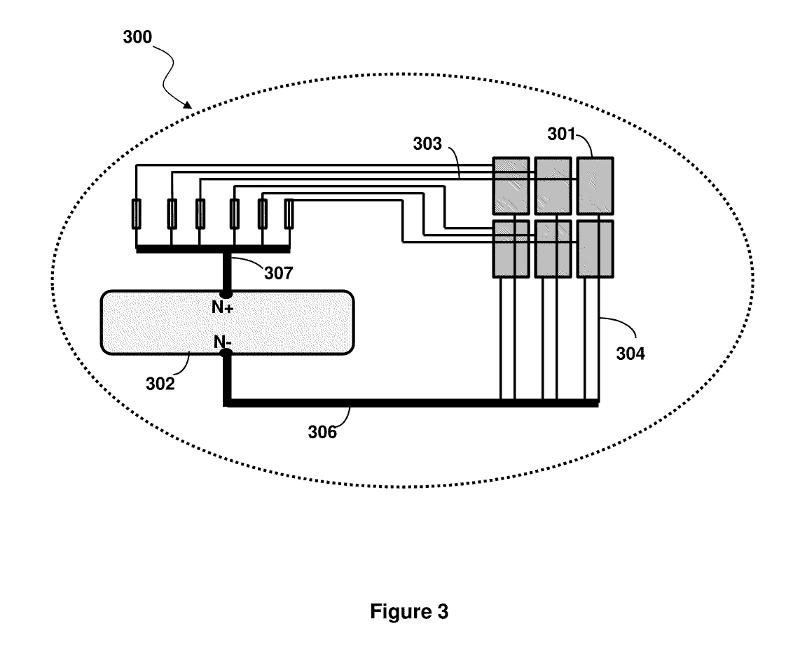

For convenience, often all of the fuses will be placed in series with either all of the positive wires, as in the case of the embodiment shown in FIG. 1, or in series with all of the negative wires. However, the fuses can be placed in series with some of the positive and some of the negative wires in a single solar installation, as long as each solar panel has a fuse in series with either the positive or negative wire. The parallel electrical connections may also be achieved by connecting one or two of the wires from each of the solar panels to a common wire bus (with one or two bus wires), and then connecting the wire bus or two wire buses to the inputs at the inverter. FIG. 2 shows one embodiment 200 in which all the negative wires 204 from panels 201 are connected to common wire bus 206 which connects in turn to the negative input N− of inverter 202. FIG. 3 shows another embodiment 300 in which all the negative wires 304 from panels 301 are connected to common wire bus 306 which connects in turn to the negative input N− of inverter 302, and in addition all the positive wires 303 from panels 301 are connected to common wire bus 307, which connects to the positive input N+ of inverter 302. In all cases, each solar panel will have its own dedicated fuse serially-connected to at least one wire connected to that solar panel.

The solar panels are arranged to minimize the average length of wire between the solar panels and the inverter. For example, solar panels arranged into a rectangle, where the length of the rectangle is not much greater than its width, will require much shorter wire on average than an arrangement into a rectangle, where the length of the rectangle is much greater than its width. The inverter is mounted close to the solar panels to further reduce the length of electrical wires from the array of solar panels to the inverter.

One of the great disadvantages of connecting all of the solar panels of a single installation in parallel is that the voltage produced is relatively low and the current produced is relatively high. For example, a prior art solar installation with 24 panels is typically connected with two strings of 12 panels connected in series, and then the 2 strings connected in parallel to the inverter. In this case and again with typical 60-cell, poly-silicon, solar panels, the operating voltage would be about 325 volts and the current would be about 16 amps. However, if all of the solar panels were to be connected in parallel, the voltage would be 27 volts and the current would be almost 200 amps.

With the high current and low voltage of a solar installation in which all solar panels are connected in parallel, the wires that connect the solar panels to the inverter need to be as short as possible. Otherwise, the power losses in the wires would be too great. At additional cost, the allowable length of the wire can be increased by increasing the cross-section of the wire. A larger cross-section reduces the resistance and the voltage drop per unit length. Rather than specify how the solar panels are arranged, where the inverter is mounted, or a table of maximum lengths vs. wire cross-section, it is sufficient to specify that all of these parameters must be controlled so that the voltage drop from the solar panels to the inverter is less than 2% of the typical peak power operating voltage of a single solar panel.

The wires do not have to be the same length. The distances between individual solar panels and the inverter will not be the same. An attempt to force the wires to be the same length would only make some of the wires longer than necessary and result in more power lost due to the extra length. The voltage at the inverter is controlled by the inverter to produce the maximum power from the solar array. Since every solar panel is connected to the input of the inverter, the operating voltage of each solar panel will be the voltage at the inverter input, plus the voltage drops along the wires connecting each panel to the inverter. With different length wires, the solar panels that are far from the inverter and have longer wires will be forced to operate at slightly higher voltages than the solar panels that are close to the inverter and have shorter wires.

The inverter will adjust the load that it presents to solar array to find the operating voltage and current from the solar array that produces the maximum power. Since the wire lengths to various solar panels are different, typically, the voltage drops between solar panels and the inverter will vary across the array. Solar panels far from the inverter with longer wires will operate slightly above the voltage that would produce peak power from those solar panels. Solar panels close to the inverter with shorter wires will operate slightly below the voltage that would produce peak power from those solar panels. However, the peak power vs. voltage for solar panels is quite flat in the region very close to the peak power point. Roughly, a + or −1% deviation from the peak power point voltage will result in about 0.1% less power produced. With a maximum power loss through the wiring from any solar panel to inverter of 2%, each of the solar panels will be operating at a voltage that is within + or −1% of its peak power voltage. Averaging across all of the solar panels in the array, with various lengths of wire, will result in a power loss due to the variation from the peak power points of about 0.05%, which is quite acceptable. lithe solar panels are mounted on a pitched roof, the inverter may be mounted either on the roof or close to the roof on one of the walls of the building. In the latter case, if there is an overhang from the pitched roof, the inverter may be mounted under that overhang. In any of the locations, the inverter is positioned close to the x-axis or y-axis centerline of array to minimize the total length of wires between the inverter and the solar panels.

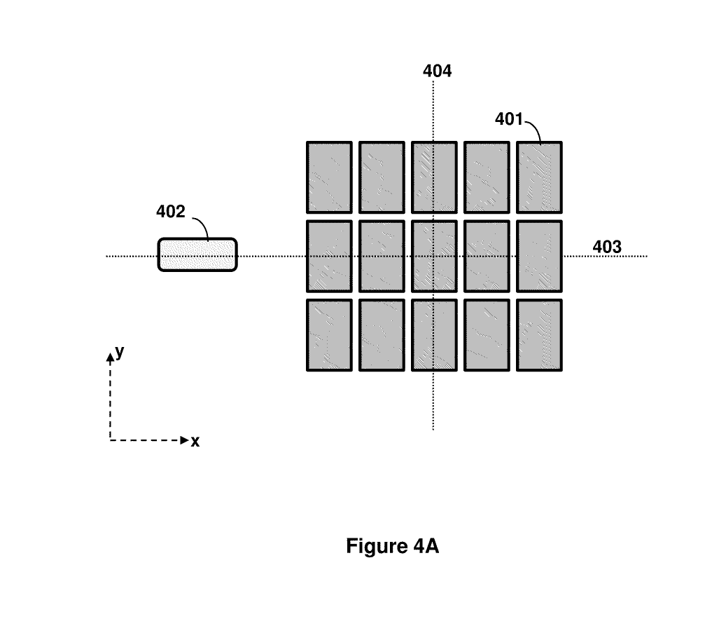

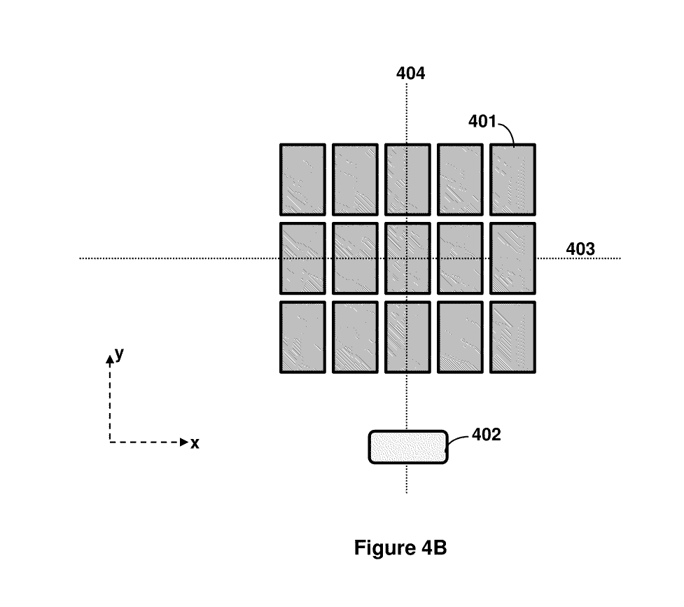

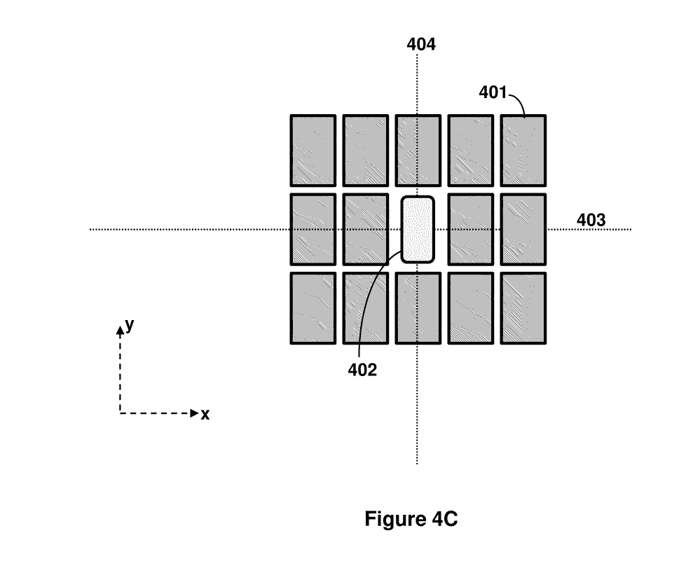

FIG. 4A is a top-down view illustrating the relative positions of panels 401 arranged in a rectangular array with a x-axis centerline 403 and a y-axis centerline 404 (the x and y axes defined as shown within the flat plane of the figure). In this case, inverter 402 is positioned close to x-axis centerline 403. In the embodiment of FIG. 4B, inverter 402 is positioned close to y-axis centerline 404, and in the embodiment of FIG. 4C, inverter 402 is positioned at the intersection of x-axis centerline 403 and y-axis centerline 404.

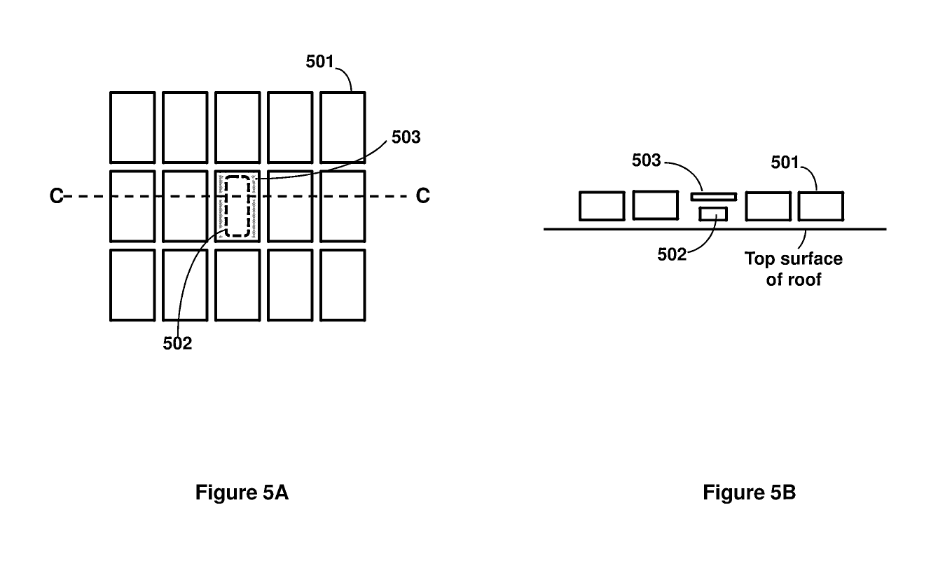

In various embodiments, if the inverter is mounted on the roof or if it is mounted on the walls of a building without any overhang from the roof, then the inverter may optionally include a sun shade. A sun shade will prevent the sun from directly heating the inverter and allow the inverter to operate at a lower temperature during the daytime. At night, a sun shade will block loss of heat from radiation and allow the inverter to be warmer at night. This sun shade can be located a few inches above the top of the inverter and extend a few inches to either side. If the inverter is mounted on the rooftop, then both the inverter and sun shade must be low enough not to shade the nearby solar panels. In one embodiment, the inverter is long and not very tall. The inverter is mounted onto the roof so that the inverter's top surface is a little lower from the top surface of the roof than the top surfaces of the solar panels also mounted onto the roof. Thus, the inverter with sun shade is at most only a little taller than the height of the solar panels from the roof. FIG. 5A shows a top down view of one embodiment where inverter 502 underlies sun shade 503 at the center of an array of panels 501. FIG. 5B shows a cross section, taken through CC, of the embodiment of FIG. 5A, showing the height of the combination of inverter and sun-shade as being approximately equal to the height of the surrounding solar panels.

As mentioned above, with all of the solar panels connected in parallel, the range of operating peak power point DC voltage from a group of solar panels (e.g. conventional 60-cell, poly-silicon solar panels) connected in parallel will be low, typically 24-33 volts. The current will be high and will depend on the number of solar panels in the installation. With 24 250-watt, conventional solar panels (6000 watts at standard test conditions), the current will be typically around 200 amps.

Low DC input voltage and high input current make it difficult to design an inverter that is competitive in both cost and energy conversion efficiency. Except for micro-inverters, prior art inverters will not accept an input voltage lower than 125 or 200 volts. Only the micro-inverters, with one micro-inverter for every 1 or 2 solar panels and many micro-inverters per solar installation, will operate with range of low voltages noted above. However, as mentioned above, using many micro-inverters for a solar installation is more expensive and has lower efficiency than using a single prior-art inverter.

A key part of the design of a solar installation, in which all of the solar panels are connected in parallel, is the design for a single inverter that can accept low input voltages and high input currents, and still be competitive with prior-art single inverters in both cost and efficiency. Without a special design for the inverter, a solar installation with all panels in parallel would not be practical.

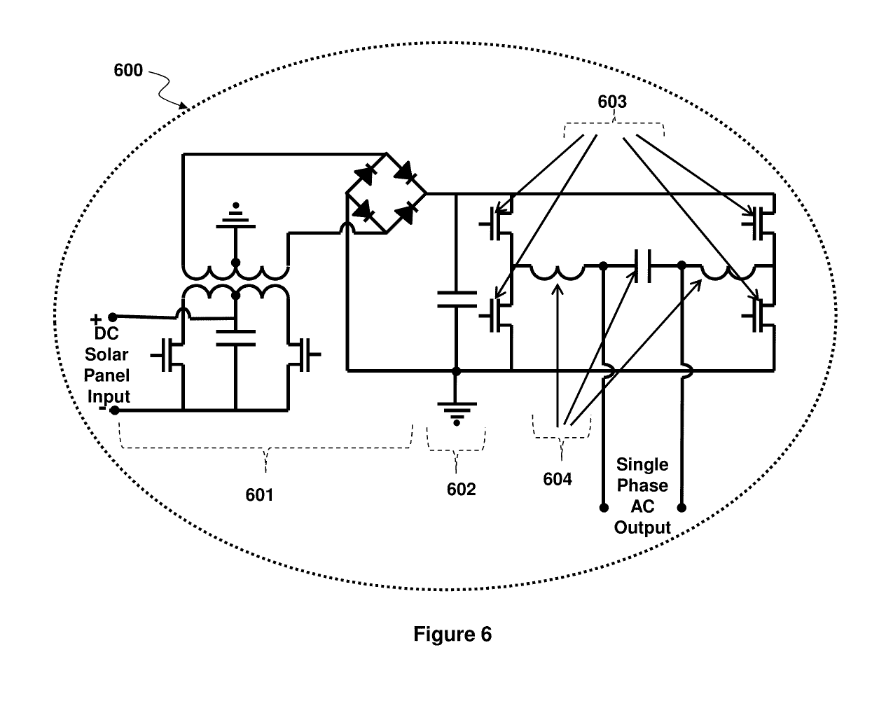

An embodiment of an inverter that is specially designed for a parallel connected array of solar panels is shown as a functional diagram in FIG. 6. Inverter 600 has four sections or stages, The first stage 601 is a fixed-ratio low voltage DC to high voltage DC converter which includes a group of switching transistors that chops the input DC voltage, applies it to a transformer that steps up that voltage by a fixed voltage ratio, and then rectifies it back to DC, but at a much higher voltage. The second stage (602) includes a high voltage DC node and a group of capacitors (shown in the FIG. 6 as a single capacitor for simplicity) for energy storage. The third stage 603 includes a pulse-width modulated “buck” set of switching transistors that are driven at high frequency (20-25 kHz) and pulse-width modulated in “buck” mode to convert the high voltage DC to instantaneous values of the AC voltage, synchronized with the AC line frequency. The fourth stage 604 includes an output filter that passes the 50 or 60 Hz power line frequency and rejects the 20-25 kHz chopping frequency. The pulse-width modulation for the third stage 603 is controlled to operate the entire solar installation at its maximum power point, to produce AC with low harmonic distortion, and to adjust for changes in the AC line voltage and load.

Please note that the embodiment illustrated in FIG. 6 provides a single-phase AC output. However, it would be simple to generalize the design for a three-phase AC output by adding a third pair of switching transistors in the third section 603 and additional filters in the fourth section 604.

The inverter in these embodiments differs from prior art inverters in two key aspects. First, the input boost stage 601 uses a fixed-ratio DC to DC converter, rather than a pulse-width modulated variable-boost input stage. In one embodiment, the fixed-ratio DC to DC converter is implemented with a transformer that also provides isolation between the solar panels and the AC power line. Second, the inverter uses an atypically large amount of energy storage at the internal high-voltage DC node in stage 602. The pulse-width modulated “buck” set of switching transistors 603 that generate 50 or 60 Hz and the output filter 604 are similar to circuits used in prior art inverters.

In one embodiment, the fixed ratio DC to DC converter 601 uses a center-tapped transformer and two groups of high power FET's to chop the input voltage at a convenient frequency, such as 20-25 kHz. The DC voltage from the solar panels is chopped, stepped up by the ratio of turns in the transformer, and then rectified to deliver power to the high-voltage node and to the energy storage capacitors in stage 602. In one embodiment, the ratio of turns in the transformer is 20:1 and the range of input voltages, typically 24-33 volts is stepped up by the fixed ratio of 20:1 and converted to a range of voltages at the high-voltage node and on the energy storage capacitors of 480-660 volts. This voltage range is well above the minimum voltage necessary for a traditional, prior art, “buck” converter to create 50 or 60 Hz AC with a voltage of 240 VAC (rms).

Prior-art single inverters are designed to handle a very large range of input voltages, usually 3:1. The large range of input voltages comes partly from changes in temperature and in the amount of sunlight. Mostly, it comes from variations in the length of the series-connected strings of solar panels. Often the number of solar panels connected in series in each string can vary by more than 2:1. With the requirement for a large input range, prior-art single inverters cannot use a fixed-ratio DC to DC converter for the input stage. The range of voltages at the internal high-voltage node would be much too great. They must use an input boost stage that has a variable step-up ratio. Usually, this is accomplished with a pulse-width modulated input boost stage to obtain good power conversion efficiency.

As described above, an array of solar panels connected in parallel will have very low input voltages and very high input currents, when compared with the voltages and currents for conventional prior-art inverters. A prior-art, pulse-width modulated input boost stage that is designed for low voltage and high current will be too expensive and/or will have poor power conversion efficiency. By combining the relatively narrow input voltage range characteristic of an array of solar panels all connected in parallel with the use of a fixed-ratio DC to DC converter with a transformer, an inverter can be designed that will be competitive in both cost and efficiency with prior-art inverters that are designed to work with arrays of solar panels connected in series.

Without a pulse-width modulated input stage, as used in prior-art inverters, the array of solar panels in the embodiments of the current invention cannot be held at exactly the input voltage and current that corresponds to their peak power point. In a single-phase AC inverter, the instantaneous power output of the inverter will vary from zero (when the AC voltage is zero) to twice the average power (when the AC voltage is at its peak). This variation in power output will cause a variation in the current drawn from the capacitors at the high-voltage node. This will cause a variation in the voltage at the high voltage node. The amount of energy storage at the high voltage node will determine the size of the variation in the voltage at the high-voltage node caused by the variation in current. Since the input stage of the inverter steps up the voltage by a fixed ratio, a variation in voltage at the high-voltage node must reflect as a similar percentage variation in the instantaneous operating voltage of the solar panels. This periodic variation will periodically move the operating voltage of the solar panels above and below their peak power operating voltage.

In one embodiment, the amount of energy storage at the high voltage node is much larger than is typically used in prior-art inverters. With a larger amount of energy storage in the inverter, the amplitude of the voltage variation at the high voltage node is reduced. The amount of energy storage is chosen so that the voltage variation at the high-voltage node will be less than + or −5% of the typical average operating voltage at the high-voltage node, when the solar panels are operating at their peak power point voltage. In one embodiment, the typical operating voltage at the high voltage node is 540 volts DC. For an inverter designed for 5000 watts of power output, the energy storage capacitors have a total capacitance of 800 uF. The amount of capacitance needed will be proportional to the output power of the inverter. For this example of 5000 watts, the amount of energy storage is ½ CV² and is equal to approximately 117 joules, and the variation in energy being drawn from the capacitors at the high-voltage node per ½ cycle of 60 Hz AC is approximately 13 joules. With 117 joules of stored energy, the variation of 13 joules in energy required for each ½ cycle of 60 Hz produces only a small variation in the voltage at the high-voltage node.

In the embodiment described above, the voltage variation at the high voltage node, caused by the periodic variation in output power, would be about 30 volts peak to peak at 120 Hz for an array with an average output power of 5000 watts. This is about + or −2.8% of the typical average voltage at the high-voltage node. This voltage variation is reduced by the turns-ratio of the transformer (20:1) to 0.75 volts peak. Since this is a fixed-ratio DC to DC converter, all of the + or −0.75 volt variation is seen by the solar panels. With a typical operating voltage of 27 volts for a group of typical 60-cell, poly-silicon solar panels in parallel, this variation is also about + or −2.8%. Since the ratio of the input voltage to the high-voltage node voltage is fixed, the percentage variation of both the solar panels and the high-voltage node must be the same.

As described above, the power output vs. voltage for solar panels is very flat near the peak power point. A variation in voltage away from the peak power point voltage of + or −2.8% creates a power loss of less than 0.2%. This amount of additional power loss is acceptable. It is much less than the additional power loss that would be incurred with a prior-art pulse-width modulated input boost stage, when operated at low voltage and high current.

In another embodiment, a solar installation consists of many solar panels (greater than 4) that are series-connected into groups of two panels each. Then, all of the series-connected groups of two panels are connected in parallel and in parallel with the input of a single inverter. Each group of two will have twice the voltage and the same current as a single panel. For the same number of panels in total, the voltage input to the inverter will be twice the voltage of a single solar panel. The current input to the inverter will be ½ the current that would have been obtained if all of the panels were connected in parallel.

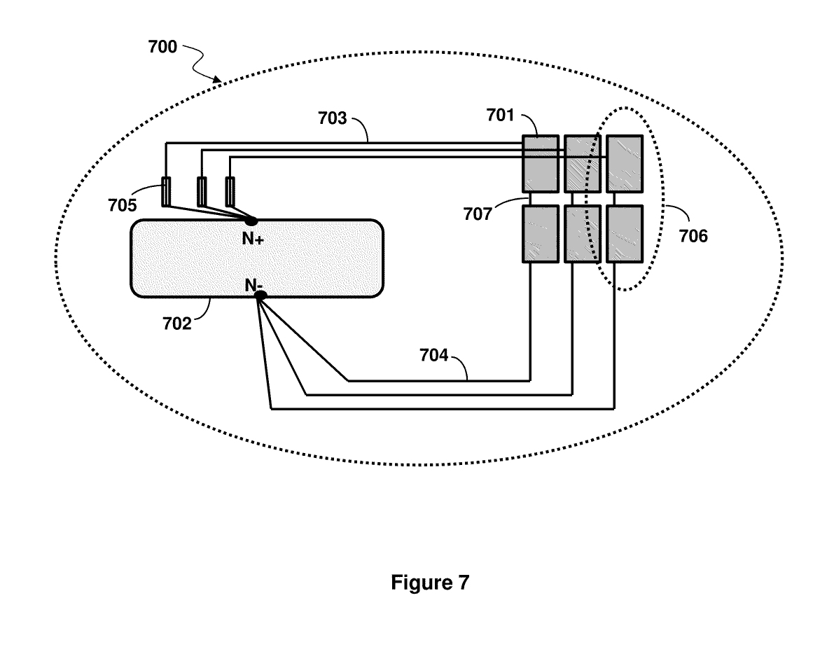

FIG. 7 shows an embodiment of an installation 700 in which pairs of panels 701 are connected in series, as indicated by wires 707. In a similar way to the embodiments of FIGS. 1-3 in which all the solar panels are connected in parallel, each group 706 of two series-connected solar panels 701 is wired to the inverter 702, with at least one of the two wires 703, 704 connecting only one group of two series-connected panels to the positive or negative inputs respectively of the inverter. As before, a fuse 705 is placed in series with one of the wires (positive wire 703 in the case illustrated) that connects each group of two panels directly to the inverter. In the event of a failure that causes one group of two panels to become a short circuit, the corresponding fuse will blow and prevent the remainder of the solar panels from dumping their power into the failed group of two panels and possibly starting a fire. The two solar panels in each series-connected group of two can be matched in current to optimize the overall efficiency of the entire solar installation. With solar panels that have a variation in their power output of −0% to +3%, matching the two panels in each group of two can improve the overall amount of power produced by as much as 0.75%.

Similar to the embodiment with all solar panels connected in parallel, in the embodiment illustrated in FIG. 7, the solar panels may be arranged to minimize the average wire length. The wire lengths are generally not all the same and the variations in voltage drops between the series-connected groups of two solar panels will not contribute significantly to power loss. The inverter is advantageously located close to the solar panels, and the inverter may be located close to the x-axis or y-axis centerlines of the array of solar panels. Also, a one or two wire bus can be used to connect the groups of two series-connected solar panels. As in the all-parallel embodiment, there must be at least one wire and fuse that connects to only one group of two series-connected solar panels. As discussed above, the inverter may be on a front or side wall, under the eaves of the roof (if there are eaves), or on the rooftop among the solar panels. If not located under the eaves, the inverter may include a sun shade. The total height of the inverter and the sun shade, and the spacing to nearby solar panels are chosen to avoid shadows from the inverter or sun shade onto any of the solar panels. Unlike the embodiment with the all solar panels connected in parallel, the voltage of each series-connected group of two will be twice the voltage of a single solar panel. Therefore, the maximum voltage drop between any series-connected group of two solar panels and the inverter can be up to 4% of the voltage of a single solar panel when the solar panel is operating at its peak power point.

Similar to the embodiment with all solar panels connected in parallel, the inverter must be specially designed for low input voltages and high input currents. With groups of two solar panels connected in series, the voltage will be twice and the current will be ½ of the corresponding values for the all-parallel case. Nevertheless, the voltage is still much lower and the current much higher than prior-art solar installations. Prior-art designs for the inverter will not result in competitive costs and efficiencies. In one embodiment, the design is similar to the one described for the all-parallel embodiment. However, one difference is that the turns-ratio on the transformer for the input DC to DC fixed-ratio converter may be 10:1 instead of 20:1 to accommodate twice the input voltage. The voltage range of the internal DC high-voltage node will be the same and the amount of energy storage will be the same.

In the embodiments and examples presented above, it may be assumed that the inverter is connected to the AC power grid, operating at 50 Hz, 60 Hz or some other power line frequency. It should be noted that all of the embodiments and examples will work equally well when the inverter is operated off-line, that is, without being attached to a power grid. In this case, the inverter will set its own frequency and phase, rather than synchronize with the frequency and phase of the power grid. In other respects, the solar installation, including the inverter, will be the same as in the embodiments and examples presented above for a power-grid connected installation.

Although the description has been described with respect to particular embodiments thereof, these particular embodiments are merely illustrative, and not restrictive. It will also be appreciated that one or more of the elements depicted in the drawings/figures can also be implemented in a more separated or integrated manner, or even removed or rendered as inoperable in certain cases, as is useful in accordance with a particular application. Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A photovoltaic solar panel installation, comprising an array of 4 or more solar panels and one DC to AC electrical power inverter, in which all of the solar panels are electrically connected in parallel to each other, and in parallel with the + and −DC inputs of the DC to AC power inverter.

2. The installation of claim 1, where each solar panel is electrically connected to either the + or the −DC input of the inverter with a wire that is connected in series with a fuse, and where the wire and fuse are not shared by any other solar panel.

3. The installation of claim 2, where the diameter and length of each of the wires are chosen such that the voltage drop between each of the solar panels and the DC input of the inverter is less than 2% of the typical voltage of a single solar panel when it is operated at its peak power point.

4. The installation of claim 3, where the inverter is mounted on the walls and/or the roof of a building, in close proximity to the array of solar panels, and the solar panels are grouped close together to minimize the length of wire between each solar panel and the inverter.

5. The installation of claim 4, where the array of solar panels is characterized by a vertical or horizontal centerline and the inverter is located on or close to the vertical or horizontal centerline.

6. The installation of claim 5, where the inverter is optimized in cost and/or efficiency based on the high current and narrow range of voltage produced by an installation in which all solar panels are connected in parallel.

7. The installation of claim 6, where the inverter uses a fixed-ratio DC to DC converter as its input boost stage and a large amount of energy storage at the internal high-voltage DC node, such that the voltage variation at the high-voltage DC node is less than + or −5% of its average value.

8. The installation of claim 7, where the inverter is mounted with a sun shade to protect it from the heat of the direct sunlight.

9. The installation of claim 8, where the inverter is mounted on the top of the roof and is designed to have a height above the roof less than or equal to the height of the solar panel array above the roof to avoid shading the solar panels.

10. A photovoltaic solar panel installation, comprising an array of 4 or more solar panels and one DC to AC electrical power inverter, in which the solar panels are first grouped into pairs of solar panels that are electrically connected together in series, and then all groups of two, series-connected, solar panels are electrically connected in parallel with each other, and in parallel with the + and −DC inputs of the DC to AC power inverter.

11. The installation of claim 10, where in each group of two series-connected panels, the corresponding two panels are matched to each other so that both panels in each pair have approximately the same output current at the peak power point for each panel.

12. The installation of claim 10, where each group of two, series-connected, solar panels is electrically connected to either the + or the −DC input of the inverter with a wire that is connected in series with a fuse, and where the wire and fuse are not shared by any other group of two, series-connected, solar panels.

13. The installation of claim 12, where the diameter and length of the wires for each pair of series-connected solar panels are chosen such that the voltage drop between the series-connected pair of solar panels and the DC input of the inverter is less than 4% of the typical voltage of a single solar panel when it is operated at its peak power point.

14. The installation of claim 13, where the power inverter is mounted on the walls and/or the roof of a building, in close proximity to the array of solar panels and the solar panels are grouped close together to minimize the length of wire between each solar panel and the inverter.

15. The installation of claim 14, where the array of solar panels is characterized by a vertical or horizontal centerline, and the inverter is located on or close to the vertical or horizontal centerline.

16. The installation of claim 15, where the inverter is optimized in cost and/or efficiency based on the high current and narrow range of voltage produced by an installation in which groups of two, series-connected, solar panels are connected in parallel.

17. The installation of claim 16, where the inverter uses a fixed-ratio DC to DC converter as its input boost stage and a large amount of energy storage at the internal high-voltage DC node, such that the voltage variation at the high-voltage DC node is less than + or −5% of its average value.

18. The installation of claim 17, where the inverter is mounted with a sun shade to protect it from the heat of the direct sunlight.

19. The installation of claim 18, where the inverter is mounted on the top of the roof and is designed to have a height above the roof less than or equal to the height of the solar panel array above the roof to avoid shading the solar panels.
